(19) United States
(12) Patent Application Publication
(10) Pub. No.: US 2026/0170940 A1
(43) Pub. Date: Jun. 18, 2026

(54) TRANSMITTER FOR A CALL BELL SYSTEM

(71) Applicant: Logistics and Supply Chain MultiTech R&D Centre Limited, Pok Fu Lam (HK)

(72) Inventors: Kwong Yeung Simon Wong, Pok Fu Lam (HK); Chung Hung Cheng, Pok Fu Lam (HK); Jing Jung Tang, Pok Fu Lam (HK); Feng Lu, Pok Fu Lam (HK)

(21) Appl. No.: 18/981,749

(22) Filed: Dec. 16, 2024

(51) Int. Cl. G08B 25/01; G08B 3/10; H02J 50/00

(52) U.S. Cl. CPC G08B 25/016; G08B 3/1016; H02J 50/001

(57) ABSTRACT

The invention relates to a transmitter for a call bell system including: a call switch arranged to send a call signal to a receiver when a user requires assistance, and an energy harvesting module arranged to be powered by a user's manipulation to ensure the operation of the transmitter remains uninterrupted. It also relates to a call bell system including: a receiver arranged to alert a caregiver when it receives a call signal, and one or more of the above-mentioned transmitters.

### TECHNICAL FIELD

The present invention relates to a transmitter, and particularly, although not exclusively, to a transmitter for a call bell system allowing users, such as residents of care facilities to alert a caregiver or hospital staff when they need assistance or have an emergency.

### BACKGROUND

A call bell system is an important communication tool often seen in hospitals, care centres, or schools where children, less mobile persons, patients, mental or physically disabled persons, or elderly persons are in need of care. The call bell system may be able to provide a function whereby patients or residents can easily alert their caregivers when they need assistance, or when there is an emergency like panic attack or fall. Typically, the call bell system includes at least one call button connected via physical wiring or a wireless network to a central monitoring system or device. When patients or residents need assistance, they could simply press the call button to send an alert signal to the monitoring system or device. The monitoring system or device then informs the caregivers or staff with a sound, indicator light, vibration and/or messages.

Common types of call bell system include wired type where a call button is connected via physical cable with the receiver; wireless type with a separate call button in wireless communication with a receiver; and digital type which has integration with mobile devices like a smart-phone or smart-watch. However, all these call bell systems substantially rely on electricity and internet connections. Any disruption in these services can render the system non-operational, and could pose a risk to the patients. For example, in wireless call bell systems, the call buttons, i.e. transmitters for sending alert signal, are often battery-powered and therefore have the potential to run out of battery. Substantial efforts are required to conduct regular battery check to make sure the transmitters work properly so as to prevent sudden power losses. Battery levels can be easily overlooked in a busy environment, and thus poses a challenge in ensuring the system's reliability. If a patient or an elderly cannot alert caregivers due to a dead transmitter battery, they may be unable to receive timely help in emergencies, potentially leading to life-threatening situations.

### SUMMARY OF THE INVENTION

In accordance with a first aspect of the present invention, there is provided a transmitter for a call bell system comprising:
a call switch arranged to send a call signal to a receiver when a user requires assistance, and
an energy harvesting module arranged to be powered by a user's manipulation to ensure the operation of the transmitter remains uninterrupted.

In an embodiment of the first aspect, the energy harvesting module comprises an energy storage unit for energizing the transmitter, and an energy harvesting block for charging the energy storage unit by harvesting ambient energy.

In an embodiment of the first aspect, the energy storage unit comprises a main energy storage element, and a backup energy storage element for charging the transmitter when the main energy storage element fails to provide electrical power.

In an embodiment of the first aspect, the main energy storage element has a higher capacity than the backup energy storage element.

In an embodiment of the first aspect, the backup energy storage element has a higher charging priority than the main energy storage element.

In an embodiment of the first aspect, the energy harvesting block is configured to harvest electromagnetic wave energy for charging the energy storage unit.

In an embodiment of the first aspect, the energy harvesting block is configured to harvest kinetic energy for charging the energy storage unit.

In an embodiment of the first aspect, the energy harvesting block is configured to harvest solar energy for charging the energy storage unit.

In accordance with a second aspect of the present invention, there is provided a call bell system comprising:
a receiver arranged to alert a caregiver when it receives a call signal from one or more transmitters, and
one or more transmitters, each of the transmitters comprises a call switch arranged to send a call signal to the receiver when a user requires assistance, and an energy harvesting module arranged to be powered by a user's manipulation to ensure the operation of the transmitter remains uninterrupted.

In an embodiment of the second aspect, the energy harvesting module comprises an energy storage unit for energizing the transmitter, and an energy harvesting block for charging the energy storage unit by harvesting ambient energy.

In an embodiment of the second aspect, the energy storage unit comprises a main energy storage element, and a backup energy storage element for charging the transmitter when the main energy storage element fails to provide electrical power.

In an embodiment of the second aspect, the main energy storage element has a higher capacity than the backup energy storage element.

In an embodiment of the second aspect, the backup energy storage element has a higher charging priority than the main energy storage element.

In an embodiment of the second aspect, the energy harvesting block is configured to harvest electromagnetic wave energy for charging the energy storage unit.

In an embodiment of the second aspect, the energy harvesting block is configured to harvest kinetic energy for charging the energy storage unit.

In an embodiment of the second aspect, the energy harvesting block is configured to harvest solar energy for charging the energy storage unit.

### BRIEF DESCRIPTION OF THE DRAWINGS

Embodiments of the present invention will now be described, by way of example, with reference to the accompanying drawings in which:

FIG. 1 is a schematic diagram of a transmitter in accordance with one embodiment of the present invention;

FIG. 2 is a schematic diagram of an energy harvesting block of the transmitter in accordance with one embodiment;

FIG. 3 is a schematic diagram of an energy harvesting block of the transmitter in accordance with another embodiment; and

FIG. 4 is a schematic diagram of an energy harvesting block of the transmitter in accordance with a further embodiment.

### DETAILED DESCRIPTION OF THE PREFERRED EMBODIMENTS

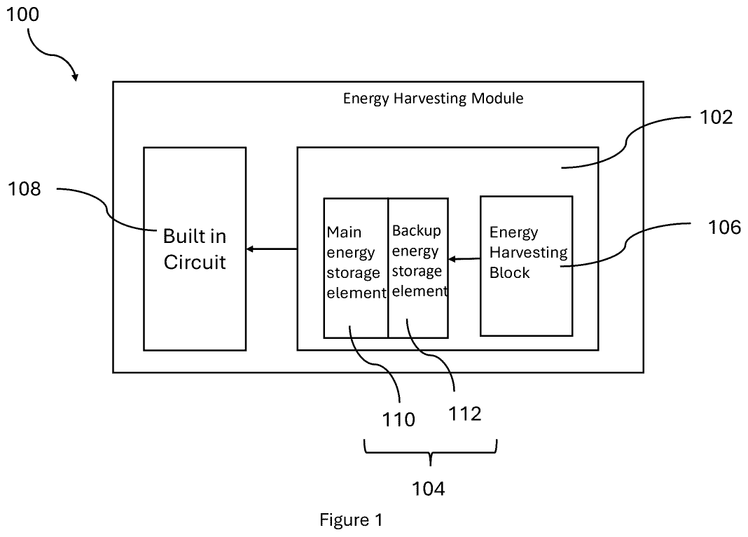

Referring to FIG. 1, there is illustrated an example embodiment of a transmitter for a call bell system. The transmitter could be applied in a wired, wireless or digital types call bell systems for transmitting a call signal to a central monitoring system via a receiver, so as to alert caregivers. In this example, the transmitter includes an energy harvesting module arranged to be powered by a user's manipulation to ensure the operation of the transmitter remains uninterrupted. The energy harvesting module can harvest the ambient energy and convert it into electrical energy to charge the transmitter. For example, the user could manipulate the transmitter by placing it under the sun to harvest solar energy for charging if the transmitter is equipped with a solar panel, or the user could shake or move the transmitter to generate kinetic energy for the energy harvesting module to convert it into electrical energy for later use.

In this embodiment, the transmitter 100 has a call switch (not shown) arranged to send a call signal to a receiver (not shown) when a user requires assistance. The transmitter includes an energy harvesting module 102 having an energy storage unit 104 and an energy harvesting block 106. The energy storage unit 104 is arranged to energize the transmitter via a built-in circuit 108, and the energy harvesting block 106 is provided to charge the energy storage unit 104 when the energy storage unit 104 runs out of energy so as to ensure the transmitter 100 continues to operate for a period of time.

In this embodiment, the energy storage unit 104 has two storage elements 110, 112. They are the main energy storage element 110 and the backup energy storage element 112. These energy storage elements 110, 112 may include batteries (replaceable single use or rechargeable batteries), a capacitor and/or a combination thereof. In an embodiment, these energy storage elements 110, 112 can be rechargeable batteries such as, but not limited to, lithium-ion batteries and nickel-metal hydride batteries, non-rechargeable batteries such as, but not limited to, alkaline batteries.

In this example, the energy harvesting module 102 may detect that there is a shortage of power supply from the main energy storage element 110, it will switch to the backup energy storage element 112 to ensure there is no interruption in the power supply to the transmitter 100. In a preferred embodiment, the main energy storage element 110 has a higher capacity than the backup energy storage element 112. This would allow the transmitter to operate for longer periods without needing to switch to the backup, and to reduce the frequency for switching between the main energy storage element 110 and the backup energy storage element 112. As such, this would help prolong the lifespan of the energy storage elements and at the same time provide a more steady performance.

In an embodiment, the backup energy storage element 112 has a higher charging priority than the main energy storage element 110. In other words, the energy harvesting module 102 will charge the backup energy storage element 112 first when it is detected that there is low energy level. For example, in an embodiment where a battery is used as the main energy storage element 110 and a super capacitor is used as backup energy storage element 112, the energy harvesting module 102 will charge the super capacitor first because the backup energy storage element has higher charging priority.

This arrangement may be advantageous as the backup energy storage element 112 is always fully charged or at least adequately energized and ready to take over when the main energy storage element 110 depletes. In turn, this may assist in ensuring a continuous power supply to operate the call bell system, which is exceptionally important in emergency situation. This would also help prolong the lifespan of the main energy storage element 112.

As discussed above, the energy harvesting module 102 in this example also includes an energy harvesting block 106 for harvesting ambient energy for charging. The energy harvesting block 106 may use various methods or devices to harvest energy, including, but not limited to, photovoltaic methods, mechanical methods, chemical methods, thermal methods, electrical methods or electro-magnetic methods. For example, the energy harvesting block may be provided to capture solar energy, electrical energy, mechanical vibrations or manipulations, including triboelectrification or similar electro-mechanical effects, chemical methods, thermal energy and/or electromagnetic waves, and convert them into usable electrical power. These ambient energies could be generated when a user carries or manipulates the transmitter. For example, vibrations and solar energies could be captured when the user is walking under the sun or by the charging of a spring or dynamo via movement. This arrangement helps prolong the lifespan of the transmitter, and keep it working for days, or even months without charging. This also help minimize risk of interruption when there is a sudden depletion of the batteries.

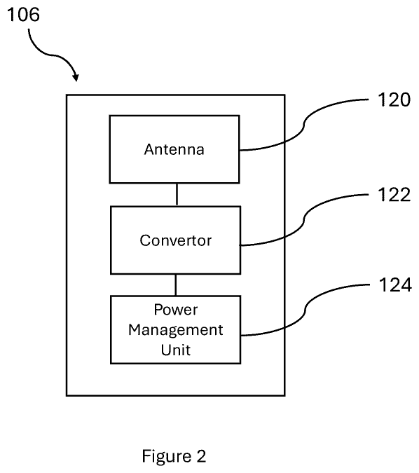

FIGS. 2 to 4 illustrate different embodiments of the energy harvesting block 106, 206, 306. As shown in FIG. 2, there is illustrated an example embodiment of an energy harvesting block 106 which harvests electromagnetic wave energy. The energy harvesting block 106 includes an antenna 120 to capture radio frequence waves from the environment and generate electrical signal, a converter 122 having a rectifier circuit connected to a power management unit 124 for converting the electrical signal, i.e. usually alternating circuit (AC) signals, into direct current (DC) signals or low frequency electric signal for use by the transmitter 106. The power management unit 124 then uses the DC power to charge the energy storge unit 104 for later use.

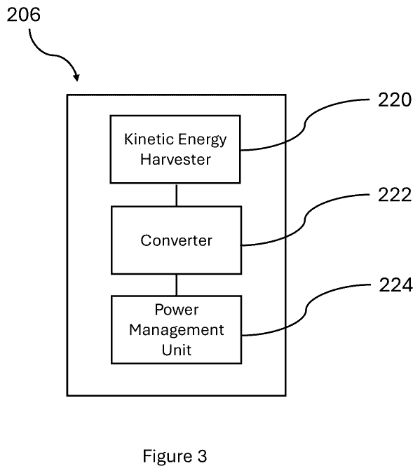

As shown in FIG. 3, there is illustrated an example embodiment of an energy harvesting block 206 which harvests kinetic energy. The energy harvesting block 206 includes an kinetic energy harvester 220 to capture energy from source like human motion, vibrations, or the like to generate electrical signal. This may include for example, mechanical switch that when manipulated could move a magnetic within a coil to generate an electric current, such as those that are found in stove starters or kinetic bells, commonly known as kinetic to electrical energy converters. The block 206 further includes a converter 222 having a rectifier circuit connected to a power management unit 224 for converting the AC signals, into DC signals or low frequency electric signal for use by the transmitter. The DC power is then saved in the energy storge unit for later use. Preferably, the convertor 222 is a circuitry in the combination of multiple phase full wave rectifier, capacitive or inductive charge pump and AC voltage transformer. The convertor 222 may use various mechanisms such as piezoelectric, electromagnetic, or electrostatic transduction to convert the mechanical energy into electrical energy.

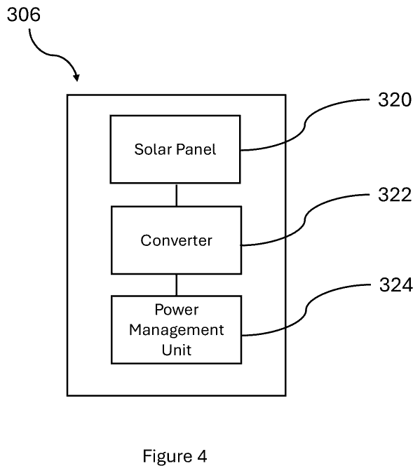

As shown in FIG. 4, there is illustrated an example embodiment of an energy harvesting block 306 which harvests solar energy. The energy harvesting block 306 includes an solar panel 320 to harvest solar energy for generation of electrical signal. The solar panel 320 can absorb sunlight and convert it into DC signals. The block 306 further includes a converter 322 having a rectifier circuit connected to a power management unit 324 for transferring DC signals to a certain DC level voltage source. The DC power is then saved in the energy storge unit for later use. Preferably, the convertor 322 is a circuitry in the combination of multiple phase full wave rectifier, capacitive or inductive charge pump and AC voltage transformer.

In use, the transmitter of the present invention is operated with a receiver to form a call bell system. The call bell system may include more than one transmitter, depending on residents, and the transmitter is as described above. The receiver could be configured as a pager to alert a caregiver when it receives a call signal from one or more transmitters. A call bell system at home could ensure family members especially the elderly to get timely assistance when needed. The elderly can wear the transmitter, e.g. by hanging it around the neck with a neck strap, or wearing it as a watch with a watch strap, and press the call button when needs assistance. It would be appreciated that the receiver could be configured to make emergency call to relevant emergency services if preferred. It is believed the instant invention provides a more reliable transmitter to monitor the situation of family members and reducing the risks of sudden power losses.

Examples of the present transmitter may be used by a user and activated or manipulated when the user desires to obtain the necessary assistance. Such use may include where a user is immobile or has experienced an accident or incident, such as a fall or other medical episodes. When the transmitter is activated, a signal is transmitted to a caregiving party and assistance may in turn be rendered to the user.

In scenarios where the standard power source is running low on power or if the user is concerned as to the amount of power in reserve (e.g. range anxiety), the user may manipulate the energy harvesting module to generate more power for the standard power source and in turn allow the transmitter to be activated. Therefore, the user may apply a physical force, such as a manipulation or vibration to generate electrical power, or the user may place the device near a electromagnetic power source, such as a wireless charging pad, or even, to a antenna power source such as a mobile phone or telecommunication equipment (e.g. WiFi router) to obtain electrical power from the electromagnetic power source, or equally useful is the user may be able to expose the device to a light source, such as sunlight or indoor lighting to obtain solar energy to supplement the power to the device. This is advantageous to users as users finding themselves in need of assistance, but where the device has no power, the user can manipulate the device to generate power to activate the transmitter. In situations where the user does not require assistance, but have a spare moment or a desire to be occupied, the user can manipulate the energy harvesting module, much like a fidget toy to generate power for the transmitter. This is particularly advantageous to certain group of individuals who may find the manipulation of objects, to have a calming or therapeutic effect.

Accordingly, the present invention provides an improved transmitter for a call bell system, as well as an improved call bell system with prolonged lifespan, and eliminates the need for frequent change of battery or battery level check. These lowers maintenance costs and at the same time minimize interruption caused by sudden depletion of batteries.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A transmitter for a call bell system comprising:
a call switch arranged to send a call signal to a receiver when a user requires assistance, and
an energy harvesting module arranged to be powered by a user's manipulation to ensure the operation of the transmitter remains uninterrupted.

2. The transmitter in accordance with claim 1, wherein the energy harvesting module comprises an energy storage unit for energizing the transmitter, and an energy harvesting block for charging the energy storage unit by harvesting ambient energy.

3. The transmitter in accordance with claim 2, wherein the energy storage unit comprises a main energy storage element, and a backup energy storage element for charging the transmitter when the main energy storage element fails to provide electrical power.

4. The transmitter in accordance with claim 3, wherein the main energy storage element has a higher capacity than the backup energy storage element.

5. The transmitter in accordance with claim 3, wherein the backup energy storage element has a higher charging priority than the main energy storage element.

6. The transmitter in accordance with claim 2, wherein the energy harvesting block is configured to harvest electromagnetic wave energy for charging the energy storage unit.

7. The call bell system in accordance with claim 2, wherein the energy harvesting block is configured to harvest kinetic energy for charging the energy storage unit.

8. The call bell system in accordance with claim 2, wherein the energy harvesting block is configured to harvest solar energy for charging the energy storage unit.

9. A call bell system comprising:
a receiver arranged to alert a caregiver when it receives a call signal from one or more transmitters, and
one or more transmitters, each of the transmitters comprises a call switch arranged to send a call signal to the receiver when a user requires assistance, and an energy harvesting module arranged to be powered by a user's manipulation to ensure the operation of the transmitter remains uninterrupted.

10. The call bell system in accordance with claim 9, wherein the energy harvesting module comprises an energy storage unit for energizing the transmitter, and an energy harvesting block for charging the energy storage unit by harvesting ambient energy.

11. The call bell system in accordance with claim 9, wherein the energy storage unit comprises a main energy storage element, and a backup energy storage element for charging the transmitter when the main energy storage element fails to provide electrical power.

12. The call bell system in accordance with claim 11, wherein the main energy storage element has a higher capacity than the backup energy storage element.

13. The call bell system in accordance with claim 11, wherein the backup energy storage element has a higher charging priority than the main energy storage element.

14. The call bell system in accordance with claim 10, wherein the energy harvesting block is configured to harvest electromagnetic wave energy for charging the energy storage unit.

15. The call bell system in accordance with claim 10, wherein the energy harvesting block is configured to harvest kinetic energy for charging the energy storage unit.

16. The call bell system in accordance with claim 10, wherein the energy harvesting block is configured to harvest solar energy for charging the energy storage unit.
